(19) United States
(12) Patent Application Publication
(10) Pub. No.: US 2020/0164540 A1
(43) Pub. Date: May 28, 2020

(54) EG-1680 Three hole electric puncher

(71) Applicant: Eagle (Shaoguan) Stationery Technology Limited, Shaoguan (CN)

(72) Inventors: Siu Leung Chan, Shaoguan (CN); Huixiong Xiong, Shaoguan (CN); Jiwu Liang, Shaoguan (CN); Xinsheng Xiao, Shaoguan (CN)

(21) Appl. No.: 16/199,131

(22) Filed: Nov. 24, 2018

(51) Int. Cl. B26F 1/14; B26D 5/08; B26D 5/16

(52) U.S. Cl. CPC B26F 1/14; B26F 2210/02; B26D 5/16; B26D 5/086

(57) ABSTRACT

The present invention belongs to the technical field of puncher, specifically involving EG-1680 Three hole electric puncher, including the base, punching device, rotating shaft and drive unit; there are at least 2 sets of said punching devices, including the support frame arranged on the base and the punching assembly that moves up and down along the said support frame; the said rotating shaft can be connected with the support frame through rotation; the rotating shaft is furnished with appropriate eccentric cams that drive the punching assembly to move up and down; the staggered arrangement of eccentric cams enables the punching assemblies to asynchronously move up and down during the rotation of rotating shaft; the said drive unit is designed to drive the rotating shaft to rotate; the asynchronous vertical motion of various punching assemblies helps to save labor, thereby alleviating the requirements for motor output power and gear strength; this product is compact in structure, easy to use, cost effective, and stable in function.

### FIELD OF INVENTION

The present invention belongs to the technical field of puncher, specifically involving EG-1680 Three hole electric puncher.

### BACKGROUND OF INVENTION

Commonly used office punchers are normally divided into manual and electric punchers by the driving form, and could be classified by punching capacity per cycle into single-hole puncher, two-hole puncher, three-hole puncher, and multi-hole puncher, the punching capacity varies from 1 to 60 pieces of paper. Common office punchers available on market are generally operated manually, thus being time consuming, laborious and difficult to use. Hence, electric punchers were developed one after another; however, punchers available on market with punching capacity of more than 20 sheets or multi-hole punchers consume much power and require high-strength gears, which leads to relatively high prices and low cost performance, and may frequently impair the service life of punchers, failing to address consumers' operational requirements.

### CONTENT OF INVENTION

The present invention is intended to present an easy-to-use compact electric puncher with high cost performance and stable functionality so as to solve the problems raised in the background art above.

To achieve the goal described above, the present invention proposes the following technical scheme:

EG-1680 Three hole electric puncher, including the base, punching device, rotating shaft and drive unit; the said punching device includes the support frame arranged on the said base and the punching assembly that moves up and down along the said support frame, of which the number is at least 2; the said rotating shaft can be connected with the support frame through rotation; the rotating shaft is furnished with appropriate eccentric cams that drive the punching assembly to move up and down; the eccentric cams are arranged with certain angle between cams so that the punching assemblies move up and down asynchronously during the rotation of rotating shaft; the said drive unit is used to drive the said rotating shaft.

Preferably, the said rotating shaft is correspondingly furnished with three eccentric cams arranged with 90° angle between each other.

Preferably, the said punching assembly includes a slide frame moving up and down along the said support frame; the said slide frame includes the integrally connected top board and base board; under the said base board is a punch; the said eccentric cams are arranged between the top board and base board of slide frame; when the flange of eccentric cam is propped against the base board, it drives the slide frame to move down along support frame, guiding the downward movement of punch to finish punching operation; when the flange of eccentric cam is propped against the top board, it drives the slide frame to move up along support frame, guiding the punch to move up and return to its home position.

Preferably, the base board of said slide frame is designed with a cushion block to increase the bearing capacity of slide frame.

Preferably, the said drive unit includes a motor and a gear box; inside the said gear box are carrier gear and drive gear connected through meshing transmission; the said carrier gear is connected with motor transmission; the said driven gear is fixed to the rotating shaft.

Preferably, the said support frame includes a left support and a right support working with each other; the said left support is provided with a through hole, through which the rotating shaft passes; the said right support is connected to rotating shaft respectively through rotor through rotation.

Preferably, the said right support is furnished with a slideway for punching assembly to move up and down; in the combined state, the said eccentric cams and punching assemblies are located in the space formed by the left and right supports.

Preferably, the lower portion of the right support is provided with a punching inlet for placing paper, and the base is correspondingly designed with a groove for mounting the right support; in the combined state, the bottom of the said punching inlet is flush with the bench surface of base; the said right support is designed with a through hole for the vertical movement of punch.

Preferably, the said rotating shaft is fixedly furnished with a touch bar; the said base is designed with the first micro switch that works with touch bar.

Preferably, an upper cover is included; the said upper cover is designed with a punch key with spring; the said base is provided with the second micro switch that works with punch key.

Preferably, the said rotating shaft is a solid square iron shaft.

Preferably, there is also a bottom cover designed with scale.

Preferably, inside the said bottom cover is a battery case.

Preferably, a PCB assembly is further included and electrically coupled to the drive unit.

Preferably, a DC socket is included.

Preferably, the said electric puncher is powered by battery or AC power source.

### Advantages and Benefits of the Present Invention

1. Compared with the prior art, the EG-1680 Three hole electric puncher drives the gear assembly and the rotating shaft to rotate through a motor so that the eccentric cam rotates in the slide frame, thereby causing the punch to move up and down along the slideway of right support for cutting paper; This product is compact in structure, easy to use, cost-effective, and stable in function.

2. In the electric puncher of the present invention there are a number of eccentric cams arranged with angular misalignments that enable the asynchronous vertical motion of punching assembly through the rotation of rotating shaft; each time the eccentric cam rotates one revolution, the punching assembly finishes a cycle of vertical reciprocating motion. The asynchronization saves labor, thereby alleviating the requirements for motor output power and gear strength.

### DESCRIPTION OF DRAWINGS

FIG. 1 is the exploded perspective view of electric puncher.

FIG. 2 is the schematic structural view of punching assembly.

FIG. 3 is the schematic view indicating the assembly of punching device, eccentric cam and rotating shaft.

FIG. 4 is the schematic view indicating the assembly of punching assembly and right support.

FIG. 5 is the schematic illustration of punching assembly with the eccentric cam rotated by 180°.

FIG. 6 is the schematic illustration of punching assembly with the eccentric cam rotated by 360°.

FIG. 7 is the schematic illustration of touch bar and the first micro switch.

FIG. 8 is the schematic structural view of drive unit.

FIG. 9 is the schematic circuit diagram of the electric puncher of the present invention.

### SPECIFIC EMBODIMENTS

To facilitate the understanding by the skilled in the art, the present invention will be further described in combination with attached drawings and embodiments.

### Embodiment 1

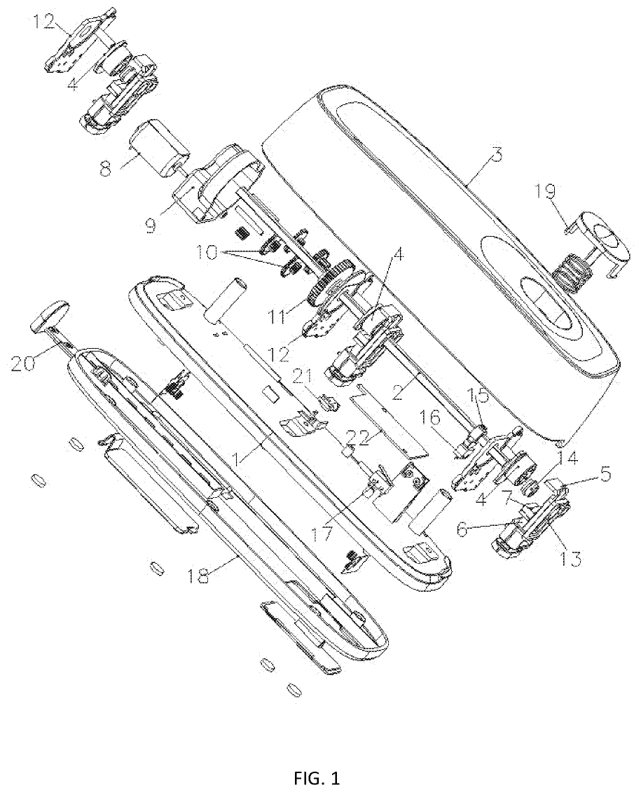

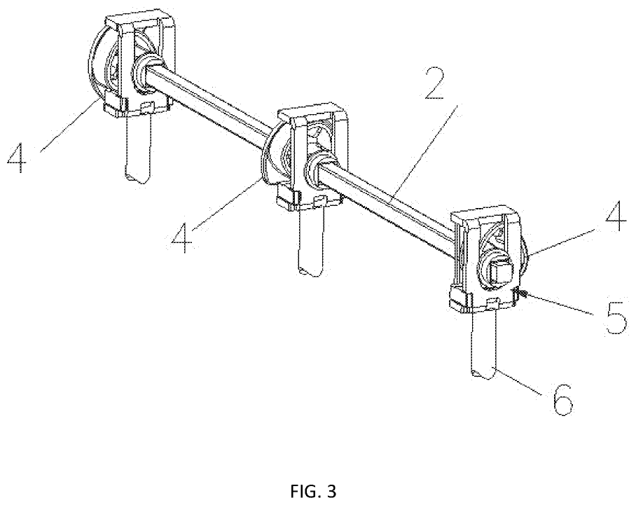

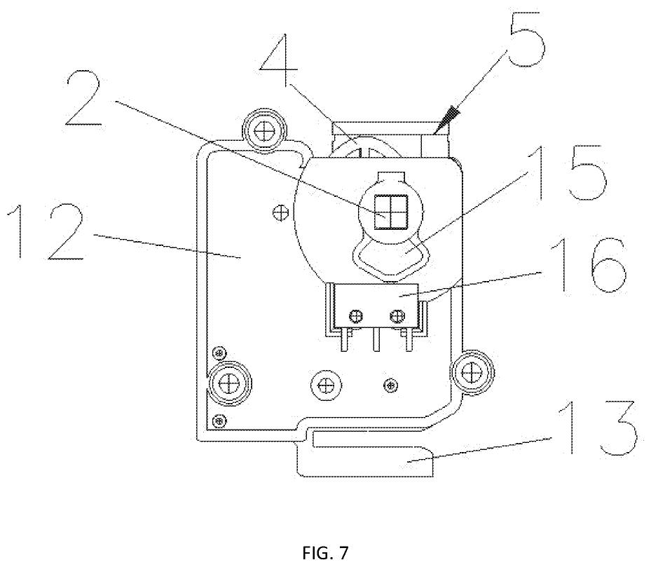

EG-1680 Three hole electric puncher as shown in FIGS. 1, 3 and 7, including the base 1, punching device, rotating shaft 2 and drive unit; the said punching device includes the support frame arranged on the said base 1 and the punching assembly that moves up and down along the said support frame, of which the number is 2 in this embodiment; the said rotating shaft 2 is a solid square iron shaft that can be connected with the support frame through rotation; the rotating shaft 2 is correspondingly furnished with appropriate eccentric cams 4 that drive the punching assembly to move up and down; the eccentric cams 4 are arranged with an angle of 90° between cams so that the punching assemblies move up and down asynchronously during the rotation of rotating shaft; rotating shaft 2 is also fixedly designed with a touch bar 15; the said base 1 is furnished with the first micro switch 16 working with touch bar 15; the said drive unit is used to drive the said rotating shaft 2.

Compared with prior art, the electric puncher EG-1680 of the present invention is designed with a number of eccentric cams 4 arranged with angular misalignments that enable the asynchronous vertical motion of punching assembly through the rotation of rotating shaft 2; each time the eccentric cam 4 rotates one revolution, the punching assembly finishes a cycle of vertical reciprocating motion. The asynchronization saves labor, thereby alleviating the requirements for motor output power and gear strength. This product is compact, easy to sue, cost effective, and stable in function.

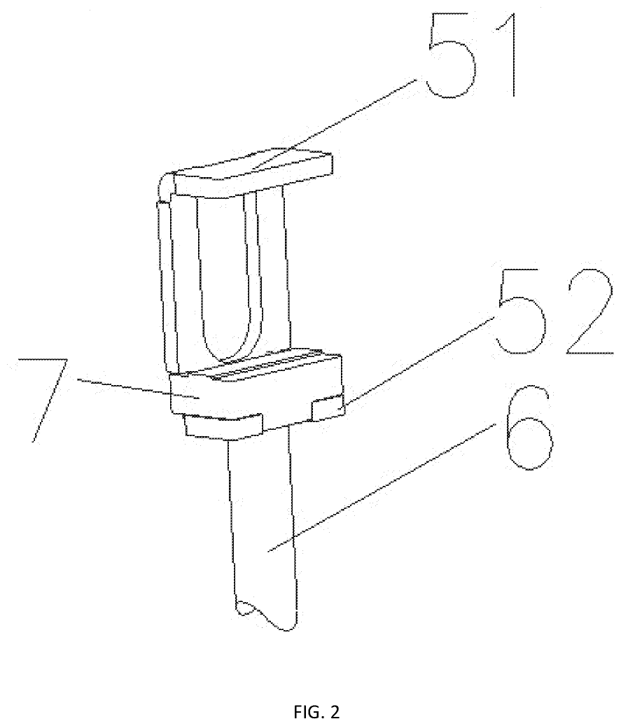

As shown in FIGS. 2, 5 and 6, the said punching assembly includes a slide frame 5 moving up and down along the said support frame; the said slide frame 5 includes the integrally connected top board 51 and base board 52; under the said base board 52 is a punch 6; the said eccentric cams 4 are arranged between the top board 51 and base board 52 of slide frame 5; when the flange of eccentric cam 4 is propped against the base board 52, it drives the slide frame 5 to move down along support frame, guiding the downward movement of punch 6 to finish punching operation; when the flange of eccentric cam 4 is propped against the top board 51, it drives the slide frame 5 to move up along support frame, guiding the punch 6 to move up and return to its home position. The base board 52 of slide frame 5 is designed with a cushion block 7 to increase the bearing capacity of slide frame 5.

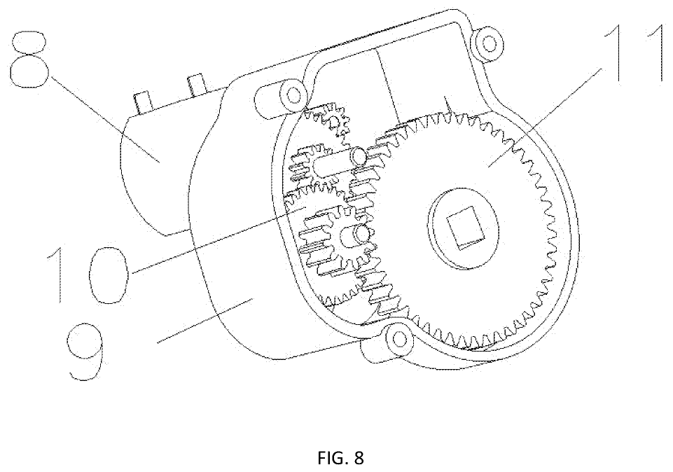

As shown in FIG. 8, the said drive unit includes a motor 8 and a gear box 9; inside the said gear box are carrier gear 10 and drive gear 11 connected through meshing transmission; the said carrier gear 10 is connected with motor 8 transmission; the said driven gear 9 is fixed to the rotating shaft 2.

Specifically, the said support frame includes a left support 12 and a right support 13 working with each other; the said left support 12 is provided with a through hole, through which the rotating shaft passes; the said right support 13 is connected to rotating shaft 2 respectively through rotor 14 through rotation.

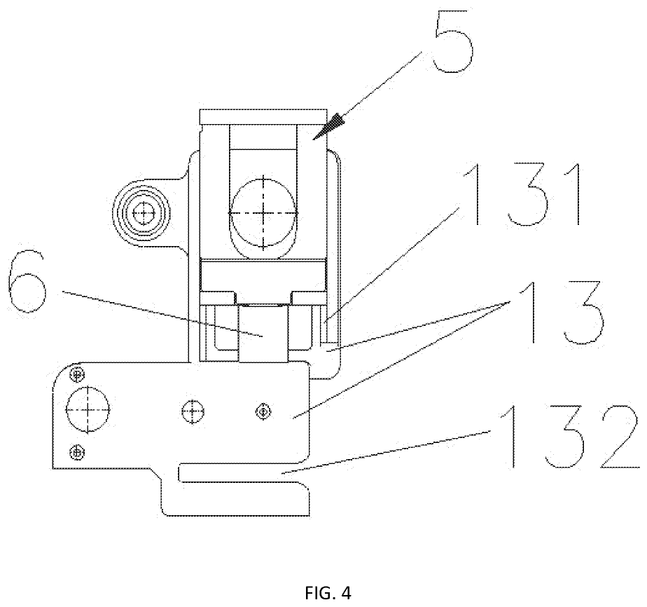

Specifically as shown in FIG. 4, the said right support 13 is furnished with a slideway 131 for punching assembly to move up and down; in the combined state, the said eccentric cams 4 and punching assemblies are located in the space formed by the left 12 and right supports 13 to assure compact structure and the stable function during operation.

Specifically as shown in FIG. 4, the lower portion of the right support 13 is provided with a punching inlet 132 for placing paper, and the base 1 is correspondingly designed with a groove 14 for mounting the right support; in the combined state, the bottom of the said punching inlet 132 is flush with the bench surface of base 1; the said right support 13 is designed with a through hole for the vertical movement of punch.

This electric puncher further includes upper cover 3 and bottom cover 18; upper cover 3 is designed with a spring-loaded punch key 19; base 1 is furnished with the second micro switch 17 that works with punch key 19; the said bottom cover 18 is provided with scale 20 that works with punching inlet 132 to limit the location of paper; inside the bottom cover is a battery case for accommodating the batteries.

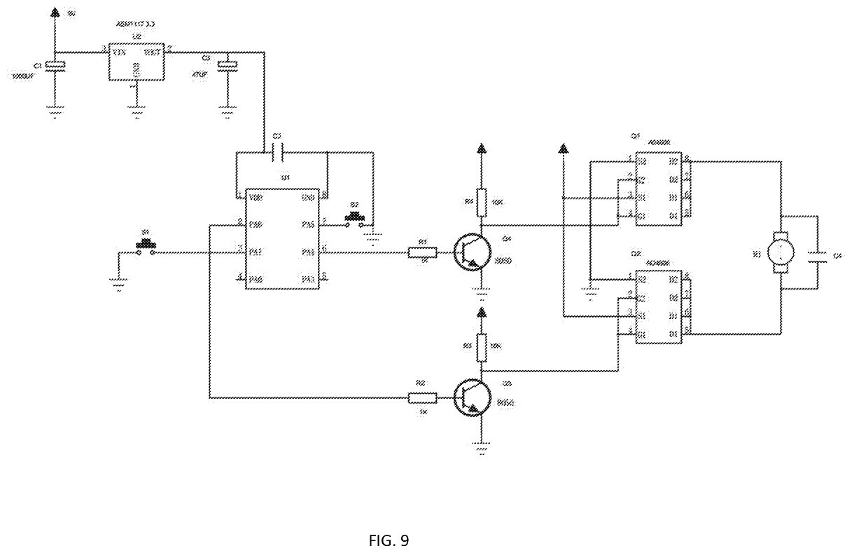

The electric puncher further includes PCB assembly 22; the said PCB assembly 22 is electrically connected with drive unit, and the schematic circuit diagram in PCB assembly is shown in FIG. 9; to avoid motor underpower resulting from excessively low voltage of (old) battery, which may cause the punch to fail to penetrate (a number of pieces of) paper, the PCB is specially designed with a reverse feature; operating principle of the PCB assembly: The motor runs forward when S1 is closed. When the motor runs forward to a certain position, S2 is closed, which causes the motor to stop; if S2 is not closed within 4 seconds after the forward operation of motor after the closing of S1, the motor will run reversely until S2 is closed and the motor stops. If S is still not closed within 4 seconds after the reverse operation of motor, the motor will stop.

The electric puncher further includes DC socket 21; the electric puncher of the present invention can be powered by battery or AC power source.

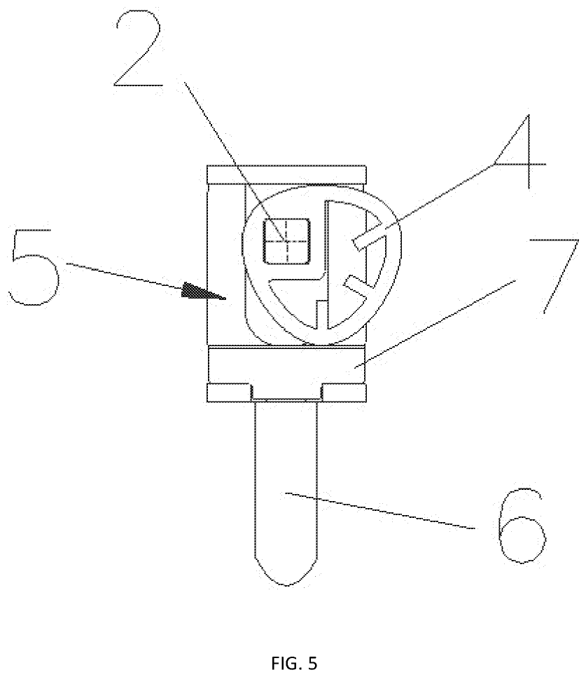

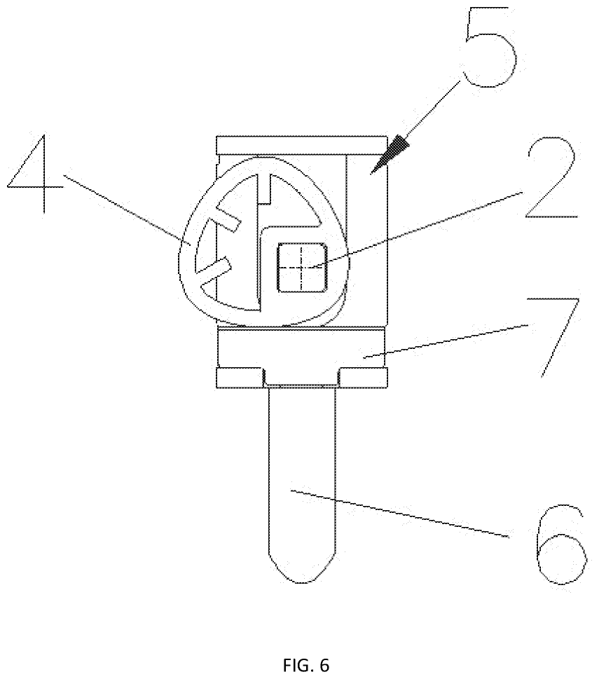

Operating principle of the electric puncher of the present invention: Put the paper at punching inlet 132; turn on the power supply; press punch key 19 and touch the second micro switch 17, when the motor 8 is started to drive the gear set, rotating shaft 2 and eccentric cam 4 to rotate; eccentric cam 4 pushes cushion block 7 to move down together with punching assembly along the slideway 131 of right support for paper cutting; as shown in FIG. 5, when the rotation angle of eccentric cam 4 reaches 180°, which is to say, the flange of eccentric cam is propped against base board 52, the punching assembly moves down to finish the punching operation; as shown in FIG. 6, when the rotation angle of eccentric cam reaches 360°, which is to say, the flange of eccentric cam is propped against top board 51, touch bar 15 touches the first micro switch 16, when motor 8 is powered off; the punching assembly moves up to its home position, and a paper-cutting cycle is finished here.

The embodiment above only deals with the preferred mode of execution of the present invention; although its description is specific and detailed, this shall in no case restrict the scope of right to the present invention. Hence, the scope of patent protection for the present invention shall be subject to the attached claims.

What is claimed is:

1. EG-1680 Three hole electric puncher, including the base, is characterized by the fact that it further includes:
A punching device, including the support frame arranged on the said base, and the punching assembly that can move up and down along the said support frame; the number of said support frames and punching assemblies is not less than 2;
A rotating shaft; the said rotating shaft can be connected with the support frame through rotation; the rotating shaft is furnished with appropriate eccentric cams that drive the punching assembly to move up and down; the eccentric cams are arranged with certain angle between cams so that the punching assemblies move up and down asynchronously during the rotation of rotating shaft;
A drive unit designed to drive the said rotating shaft to rotate.

2. The electric puncher as described in claim 1; it is characterized by the fact that there are three sets of said support frames and punching assemblies; the said rotating shaft is correspondingly furnished with three eccentric cams arranged with 90° angle between each other.

3. The electric puncher as described in claim 1; it is characterized by the fact that the said punching assembly includes a slide frame moving up and down along the said support frame; the said slide frame includes the integrally connected top board and base board; under the said base board is a punch; the said eccentric cams are arranged between the top board and base board of slide frame; when the flange of eccentric cam is propped against the base board, it drives the slide frame to move down along support frame, guiding the downward movement of punch to finish punching operation; when the flange of eccentric cam is propped against the top board, it drives the slide frame to move up along support frame, guiding the punch to move up and return to its home position.

4. The electric puncher as described in claim 3; it is characterized by the fact that the base board of the said slide frame is designed with cushion block.

5. The electric puncher as described in claim 1; it is characterized by the fact that the said drive unit includes a motor and a gear box; inside the said gear box are carrier gear and drive gear connected through meshing transmission; the said carrier gear is connected with motor transmission; the said driven gear is fixed to the rotating shaft.

6. The electric puncher as described in claim 1; it is characterized by the fact that the said support frame includes a left support and a right support working with each other; the said left support is provided with a through hole, through which the rotating shaft passes; the said right support is connected to rotating shaft respectively through rotor through rotation.

7. The electric puncher as described in claim 6; it is characterized by the fact that the said right support is furnished with a slideway for punching assembly to move up and down; in the combined state, the said eccentric cams and punching assemblies are located in the space formed by the left and right supports.

8. The electric puncher as described in claim 6; it is characterized by the fact that the lower portion of the right support is provided with a punching inlet for placing paper, and the base is correspondingly designed with a groove for mounting the right support; in the combined state, the bottom of the said punching inlet is flush with the bench surface of base; the said right support is designed with a through hole for the vertical movement of punch.

9. The electric puncher as described in claim 1; it is characterized by the fact that the said rotating shaft is fixedly furnished with a touch bar; the said base is designed with the first micro switch that works with touch bar.

10. The electric puncher as described in claim 1; it is characterized by the fact that it further includes the upper covers arranged around the punching device, the rotating shaft and the drive unit; an upper cover is included; the said upper cover is designed with a punch key with spring; the said base is provided with the second micro switch that works with punch key.

11. The electric puncher as described in claim 1; it is characterized by the fact that the said rotating shaft is a solid square iron shaft.

12. The electric puncher as described in claim 1; it is characterized by the fact that it further includes a bottom cover arranged at the bottom of base; the said bottom cover is provided with a scale.

13. The electric puncher as described in claim 12; it is characterized by the fact that a battery case for accommodating battery is arranged in the said bottom cover.

14. The electric puncher as described in claim 1; it is characterized by the fact that a PCB assembly is further included and electrically coupled to the drive unit.

15. The electric puncher as described in claim 1; it is characterized by the fact that it further includes a DC socket; the said electric puncher is powered by battery or AC power source via DC socket.
